(19) United States
(12) Patent Application Publication
(10) Pub. No.: US 2015/0202816 A1
(43) Pub. Date: Jul. 23, 2015

(54) Apparatus of Fabricating Water-Repellent Fabric

(71) Applicant: Auspring Co.,Ltd., Taipei City (TW)

(72) Inventors: Shui-Ching Lin, Taipei City (TW); Kai Yan, Taipei City (TW); Chun-Tiao Hsu, Taipei City (TW); Tang-Chun Chang, Taipei City (TW); Chien-Chung Chen, Taipei City (TW)

(21) Appl. No.: 14/594,264

(22) Filed: Jan. 12, 2015

(30) Foreign Application Priority Data
Jan. 17, 2014 (TW) 103200968

(51) Int. Cl. B29C 47/00; B29C 47/40; B29C 47/88

(52) U.S. Cl. CPC B29C 47/0014; B29C 47/8895; B29C 47/40; B29K 2101/12

(57) ABSTRACT

An apparatus is provided to fabricate a water-repellent fabric. At first, a water-repellent agent is evenly dispersed into masterbatches. Then, the masterbatches is added into fibers to make yarn. At last, the fabric is made with the yarn. Thus, the water-repellent fabric obtains good washing fastness and avoids contaminating the spinning device.

### TECHNICAL FIELD OF THE INVENTION

The present invention relates to fabricating a fabric; more particularly, relates to evenly mixing a water-repellent agent into the fabric to obtain good washing fastness and avoid contaminating the spinning device.

### DESCRIPTION OF THE RELATED ART

Traditionally, the method of making water-repellent yarn is to mix a water-repellent agent into a spin finish at a spinning mouth so that the water-repellent agent can be adhered on a yarn and then dried.

However, the above traditional method of making water-repellent fabric not only causes pollution of the spinning device, but also leads to uneven dispersion of the water-repellent agent on the yarn, which makes the fabric made by the water-repellent yarn have poor washing fastness.

Hence, the prior art does not fulfill all users' requests on actual use.

### SUMMARY OF THE INVENTION

The main purpose of the present invention is to evenly mix a water-repellent agent into a fabric to obtain good washing fastness and avoid contaminating the spinning device.

To achieve the above purpose, the present invention is an apparatus of fabricating a water-repellent fabric, comprising a masterbatch-making device; a plurality of water-repellent masterbatches made by the masterbatch-making device; a yarn-making device connected with the masterbatch-making device; and a fabric-making device connected with the yarn-making device, where the masterbatch-making device comprises a mixing unit; a high-speed powder-kneading device connected with the mixing unit; a cooling tank connected with the powder-kneading device at a side; a grain-cutting device connected with the cooling tank at a side; and a collecting trough connected with the grain-cutting device at a side; where the yarn-making device comprises a drawing device connected with the collecting trough; a collecting-roll device corresponding to the drawing device at a side; and a plurality of contact rollers between the drawing device and the collecting-roll device; and where each of the water-repellent masterbatches comprises 0.5%˜30% of a fluorine-containing compound, 0.01%˜6% of a dispersant and 70%˜99.5% of a polymer substrate carrier. Accordingly, a novel apparatus of fabricating a water-repellent fabric is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the water-repellent fabric fabricated by the present invention;

FIG. 2 is the enlarged view showing the area ‘a’ in FIG. 1;

FIG. 3 is the view showing the preferred embodiment according to the present invention.

FIG. 4 is the view showing the masterbatch-making device;

FIG. 5 is the view showing the yarn-making device; and

FIG. 6 is the view showing the fabric-making device.

### DESCRIPTION OF THE PREFERRED EMBODIMENT

The following description of the preferred embodiment is provided to understand the features and the structures of the present invention.

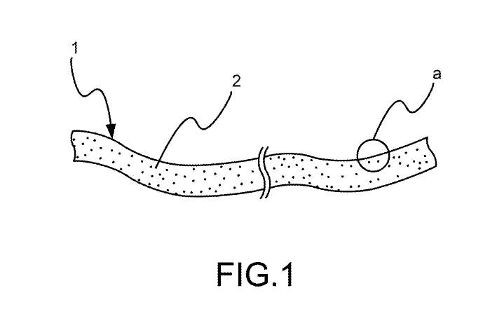

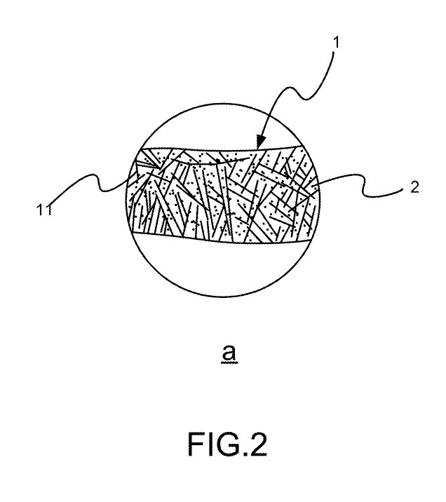

Please refer to FIG. 1 and FIG. 2, which are a view showing a water-repellent fabric fabricated by the present invention; and an enlarged view showing area ‘a’ in FIG. 1. As shown in the figures, the present invention fabricates a fabric 1 with a plurality of water-repellent masterbatches 2.

The fabric 1 comprises a plurality of fibers 11, where the fiber 11 has a round, hollow, cross or putamen shape and is a yarn or a nonwoven fiber.

Each of the masterbatches 2 is combined into the fibers 11 of the fabric 1 and comprises 0.5%˜30% of a fluorine-containing compound, 0.01%˜6% of a dispersant and 70%˜99.5% of a polymer substrate carrier. Therein, the polymer substrate carrier is polytrimethylene terephthalate (PTT), polybutylene terephthalate (PBT), polyethylene terephthalate (PET), polypropylene (PP), polyethylene (PE), nylon 6, nylon 6,12, nylon 6,6 or a mixture of compounds thereof. The fluorine-containing compound, the dispersant and the polymer substrate carrier are mixed by a high-speed powder-kneading device to evenly disperse the fluorine-containing compound into the polymer substrate carrier for forming a water-repellent polymer-substrate powder. Therein, the powder-kneading device processes kneading at a rotational speed of 400 RPM˜1800 RPM for 3˜90 minutes; the water-repellent polymer-substrate powder is kneaded and granulated by a twin-screw kneading device to form the water-repellent masterbatches having uniform and smooth surface; and the twin-screw kneading device is operated at a temperature of 220° C.˜300° C. and a rotational speed of 200 RPM˜500 RPM. Then, the water-repellent masterbatches 2 are hot-dried at a temperature of 110° C.˜140° C. for 3˜30 hours to obtain the dried water-repellent masterbatches 2.

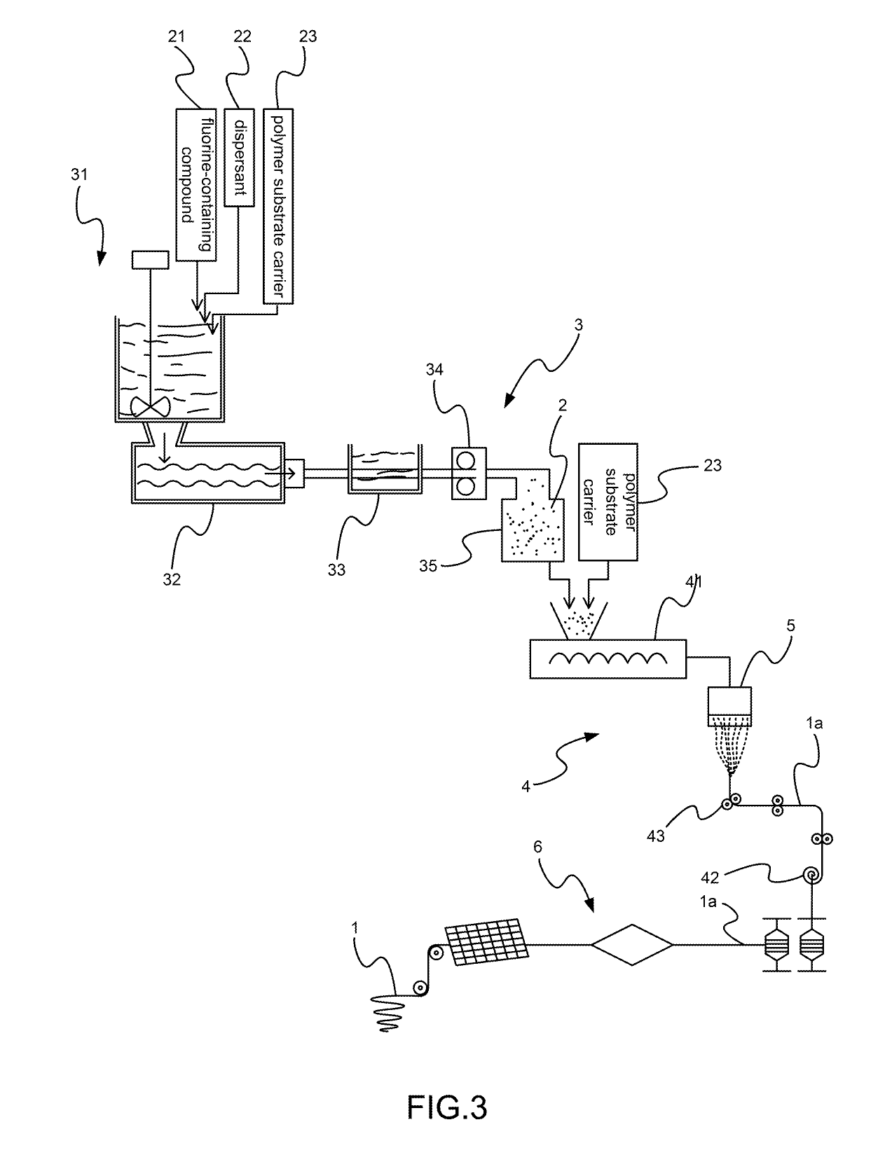

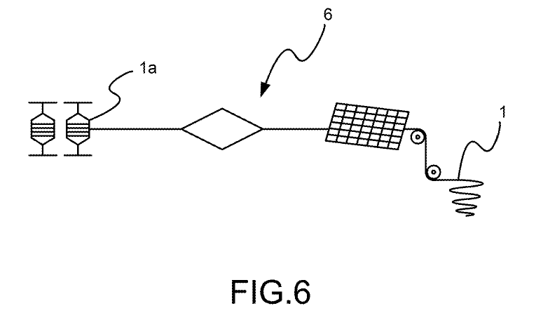

Please refer to FIG. 3 to FIG. 6, which are a view showing a preferred embodiment according to the present invention; and views showing a masterbatch-making device, a yarn-making device and a fabric-making device. As shown in the figures, the present invention is an apparatus of fabricating a water-repellent fabric, comprising a masterbatch-making device 3; a plurality of water-repellent masterbatches 2 fabricated by the masterbatch-making device 3; a yarn-making device 4 connected with the masterbatch-making device 3; and a fabric-making device connected with the yarn-making device 4. The masterbatch-making device 3 comprises a mixing unit 31, a high-speed powder-kneading device 32 connected with the mixing unit 32, a cooling tank 33 connected with the powder-kneading device 32 at a side, a grain-cutting device 34 connected with the cooling tank 33 at a side, and a collecting trough 35 connected with the grain-cutting device 34 at a side. The yarn-making device 4 comprises a drawing device 41 connected with the collecting trough 35, a collecting-roll device 42 being corresponding to the drawing device 41 at a side; and a plurality of contact rollers 43 between the drawing device 41 and the collecting-roll device 43. Thus, a novel apparatus of fabricating a water-repellent fabric is obtained.

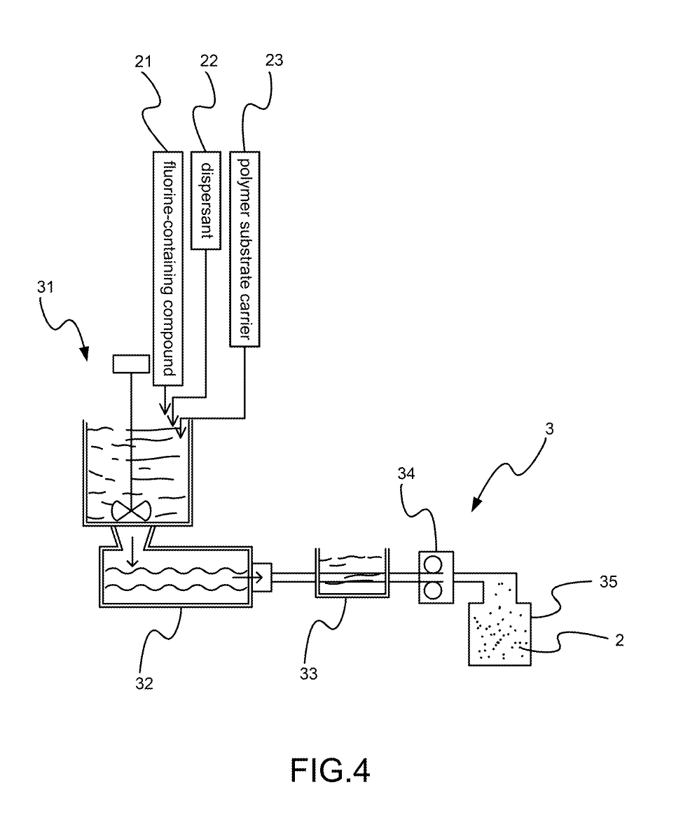

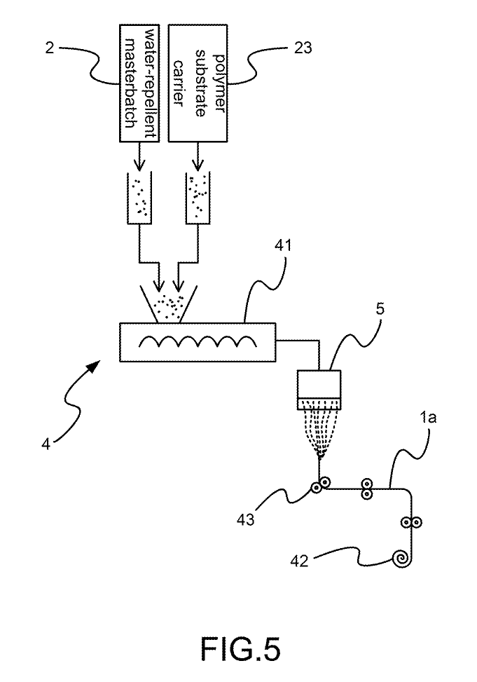

On fabricating the water-repellent masterbatches, a fluorine-containing compound 21, a dispersant 22 and a polymer substrate carrier 23 are mixed in the mixing unit 31 to fabricate the water-repellent masterbatches 2 with coordination of the powder-kneading device 32, the cooling tank 33 and the grain-cutting device 34. Then, the water-repellent masterbatches 2 is collected in the collecting trough 35 (shown in FIG. 4). Then, the water-repellent masterbatches 2 is put in the drawing device 41 with the polymer substrate carrier 23, where 0.5%˜10% of the water-repellent masterbatches are added into the polymer substrate carrier 23 to fabricate a water-repellent yarn 1a having a thickness of 1˜100 deniers with coordination of a spinning nozzle 5 and the water-repellent yarn 1a is collected by the collecting-roll device 42 through the contact rollers 43 (shown in FIG. 5). For fabricating a fabric 1 (like a textile), a plurality of fibers 11 of the fabric 1 is fabricated with the water-repellent yarn 1a by the present invention, where a water-repellent agent is evenly mixed into the fibers 11 (shown in FIG. 3).

Furthermore, 0.5%˜10% of the water-repellent masterbatches 2 can be added to a fabric material (yarn) to process melt-blow spinning for obtaining a non-woven fabric.

To sum up, the present invention is an apparatus of fabricating a water-repellent fabric, where a water-repellent agent is evenly mixed into a fabric to obtain good washing fastness and avoid contaminating the spinning device.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus of fabricating a water-repellent fabric, comprising
a masterbatch-making device;
a plurality of water-repellent masterbatches, said water-repellent masterbatches being obtained from said masterbatch-making device;
a yarn-making device, said yarn-making device being connected with said masterbatch-making device; and
a fabric-making device, said fabric-making device being connected with said yarn-making device,
wherein said masterbatch-making device comprises
a mixing unit;
a high-speed powder-kneading device connected with said mixing unit;
a cooling tank connected with said powder-kneading device at a side of said powder-kneading device;
a grain-cutting device connected with said cooling tank at a side of said cooling tank; and
a collecting trough connected with said grain-cutting device at a side of said grain-cutting device;
wherein said yarn-making device comprises
a drawing device connected with said collecting trough;
a collecting-roll device being corresponding to said drawing device at a side of said drawing device; and
a plurality of contact rollers between said drawing device and said collecting-roll device; and
wherein each of said water-repellent masterbatches comprises 0.5%˜30% of a fluorine-containing compound, 0.01%˜6% of a dispersant and 70%˜99.5% of a polymer substrate carrier.

2. The apparatus according to claim 1,
wherein said fluorine-containing compound, said dispersant and said polymer substrate carrier are mixed by said powder-kneading device to evenly disperse said fluorine-containing compound into said polymer substrate carrier to obtain a water-repellent polymer-substrate powder.

3. The apparatus according to claim 1,
wherein said powder-kneading device processes kneading at a rotational speed of 400 RPM˜1800 RPM for 3˜90 minutes.

4. The apparatus according to claim 1,
wherein said polymer substrate carrier is selected from a group consisting of polytrimethylene terephthalate (PTT), polybutylene terephthalate (PBT), polyethylene terephthalate (PET), polypropylene (PP), polyethylene (PE), nylon 6, nylon 6,12, nylon 6,6 and a mixture of compounds thereof.

5. The apparatus according to claim 1,
wherein said water-repellent polymer-substrate powder is kneaded and granulated by a twin-screw kneading device to obtain said water-repellent masterbatches having uniform and smooth surface.

6. The apparatus according to claim 5,
wherein said twin-screw kneading device is operated at a temperature of 220° C.˜300° C. and a rotational speed of 200 RPM˜500 RPM.

7. The apparatus according to claim 1,
wherein said water-repellent masterbatches are hot-dried at a temperature of 110° C.˜140° C. for 3˜30 hours to obtain said dried water-repellent masterbatches.

8. The apparatus according to claim 7, wherein 0.5%˜10% of said water-repellent masterbatches are added to fabricate a fabric.
